(19) United States
(12) Patent Application Publication
(10) Pub. No.: US 2010/0178588 A1
(43) Pub. Date: Jul. 15, 2010

(54) FABRICATING SOLID OXIDE FUEL CELLS

(75) Inventors: Bradley White, Vancouver (CA); Olivera Kesler, Toronto (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: THE UNIVERSITY OF BRITISH COLUMBIA, Vancouver, BC (CA)

(21) Appl. No.: 12/602,618

(22) PCT Filed: May 30, 2008
(86) PCT No.: PCT/CA2008/001058

§ 371 Date: Dec. 1, 2009

Related U.S. Application Data
(60) Provisional application No. 60/941,634, filed on Jun. 1, 2007.

(51) Int. Cl. H01M 8/10; H01M 4/88; C23C 4/12; C23C 4/10

(52) U.S. Cl. 429/495; 427/115; 427/446; 427/453

(57) ABSTRACT

A method for making a solid oxide fuel cell component includes depositing a cathode material directly onto a metallic interconnect. The interconnect may comprise stainless steel or another suitable metal. The cathode material may comprise a ceramic. Examples of cathode materials are yttria-stabilized zirconia (YSZ) and mixtures of YSZ with other ceramics such as lanthanum strontium manganate. The cathode material may be deposited by plasma spraying. A pore former may be plasma sprayed together with the cathode material to provide a porous cathode. Electrolyte and anode materials may be deposited on the cathode material also by plasma spraying. Plasma conditions may be selected to provide a dense electrolyte layer.

### CROSS-REFERENCE TO RELATED APPLICATION

This application claims priority from U.S. application 60/941,634 filed 1 Jun. 2007. For purposes of the United States of America, this application claims the benefit under 35 U.S.C. §119 of U.S. application 60/941,634 filed 1 Jun. 2007 and entitled FABRICATING SOLID OXIDE FUEL CELLS.

### TECHNICAL FIELD

This invention relates to fuel cells and, in particular to solid oxide fuel cells ('SOFCs'). Embodiments of the invention provide methods for fabricating SOFCs.

### BACKGROUND

Fuel cells convert chemical energy of suitable fuels into electrical energy without combustion and with little or no emission of pollutants. Fuel cells may be made on a wide variety of scales. Fuel cells can be used to generate electrical power in any of a wide variety of applications including powering vehicles, auxiliary power units (APUs), and cogeneration of power and heat for residential and business uses.

Solid Oxide Fuel Cells (SOFCs) are solid-state fuel cells. SOFCs can be highly efficient. One application of SOFCs is in stationary power generation, including both large-scale central power generation and distributed generation in individual homes and businesses.

A variety of processing techniques have been suggested for manufacturing SOFCs and their components.

SOFC processing typically includes a combination of wet powder compaction steps, such as tape casting or extrusion, followed by deposition by a chemical or physical process such as spray pyrolysis, screen printing, or electrochemical vapor deposition, and then densification at elevated temperatures. The nature of the multi-step wet ceramic manufacturing procedures makes control over the electrode microstructure and material composition difficult. The complex multi-step processing procedures are time consuming and involve significant capital costs, particularly when scaled up for mass production. Examples of methods that may be used for making SOFCs are described in D. Stöver, H. Buchkremer and S. Uhlenbruck, Ceramics International, 30, 1107 (2004).

Due to the possibility of undesired reactions and the different heating requirements, multiple fabrication steps are often required for each of the cell layers as described in S. P. Jiang, J. Power Sources, 124, 390 (2003).

There is also a drive to reduce the cost of SOFCs by using metallic interconnect supported cells as described in P. Charpentier, P. Fragnaud, D. M. Schleich and E. Gehain, Solid State Ionics, 135, 373 (2000). Supporting the cells mechanically on metallic interconnects increases mechanical robustness, while reducing heat-up times. It also allows SOFCs to be made with thinner layers of the more expensive anode, cathode, and electrolyte materials. This has the potential to provide both lower material costs and improved performance by reducing losses due to diffusion and ohmic resistance. However, the use of metal interconnect supports imposes limits on both processing and operating temperatures, requiring both costly inert atmosphere furnaces and electrolyte material compositional variations for fabrication, while also limiting operating temperatures to below ˜800° C. The lower operating temperatures required by the use of metals also significantly lowers the performance of SOFCs, thus necessitating highly optimized electrode microstructures and thin electrolyte layers to achieve sufficiently high performance. These challenges are described in the following references:
P. Charpentier, P. Fragnaud, D. M. Schleich and E. Gehain, Solid State Ionics, 135, 373 (2000).
Marius \check{Z}adyvdas, Sigitas Tamulevicius and Tomas Grinys, Materials Science (Med\check{z}iagotyra), 10, 349 (2004).
M. Lang, T. Franco, G. Schiller and N. Wagner, J. Appl. Electrochem., 32, 871 (2002).
Jürgen Fleig, Annu. Rev. Mater. Res., 33, 361 (2003).
E. Perry Murray, M. J. Sever and S. A. Barnett, Solid State Ionics, 148, 27 (2002).

Some publications in the general field of this technology include:
US 20040018409A1
US 20050058883A1
U.S. Pat. No. 5,342,703
WO03/075383
B. D. White, O. Kesler, N. Ben-Oved and A. Burgess, Preparation of an SOFC LSM/YSZ composite cathode by air plasma spraying presented at the International Thermal Spray Conference and Exposition, May 17, 2006, Seattle Wash. (which is hereby incorporated herein by reference).
B. D. White and O. Kesler, Air Plasma Spraying of LSM/YSZ Composite SOFC Cathodes presented at the THERMEC' 2006 International Conference on Processing & Manufacturing of Advanced Materials, Jul. 7, 2006, Vancouver BC (which is hereby incorporated herein by reference).
Ma X Q, Zhang H, Dai J, Roth J, Hui R, Xiao T D, Reisner D E, Intermediate temperature solid oxide fuel cell based on fully integrated plasma-sprayed components JOURNAL OF THERMAL SPRAY TECHNOLOGY 14 (1): 61-66 MAR 2005.
Zheng R, Zhou X M, Wang S R, Wen T L, Ding C X, A study of Ni+8YSZ/8YSZ/La0.6Sr0.4CoO3 fabricated by atmospheric plasma spraying JOURNAL OF POWER SOURCES 140 (2): 217-225 Feb. 2, 2005

The inventors have recognized a need for cost-efficient methods for making solid oxide fuel cells and their components and a need for methods for fabricating solid oxide fuel cells having improved performance.

### SUMMARY

The following embodiments and aspects thereof are exemplary and illustrative, not limiting in scope.

One aspect of the invention provides methods for making SOFCs or their components which involve depositing a cathode directly onto on a porous metallic interconnect. Additional layers of the SOFC are deposited over the cathode. The deposition of the cathode may be performed by plasma spraying, which may comprise atmospheric plasma spraying.

Another aspect of the invention provides methods for making SOFCs or their components which involve fabricating an SOFC cathode and subsequently depositing an electrolyte layer onto the cathode by a process such as plasma spraying, without heating the cathode to a high temperature (i.e. a temperature in excess of 1300-1400° C.).

Another aspect of the invention provides a solid oxide fuel cell component comprising a thermal-sprayed layer of ceramic cathode material formed directly on a metallic interconnect.

Additional aspects of the invention and features of specific embodiments of the invention are described below and shown in the accompanying drawings.

### BRIEF DESCRIPTION OF THE DRAWINGS

The accompanying drawings show example embodiments of the invention.

FIG. 1 is a cross-sectional view of a typical SOFC.

FIG. 2 is a flow chart illustrating a method according to the invention.

FIGS. 3A through 3D illustrate steps in fabricating an SOFC according to the method of FIG. 1.

FIG. 4 is a schematic illustration of a set up for applying a layer in the manufacture of an SOFC by plasma spraying.

FIG. 5 is a cross section through a cathode-cathode symmetrical cell as used for demonstration purposes.

FIGS. 6A, 6B and 6C are micrographs showing surfaces of cathode layers deposited directly onto a metallic interconnect by plasma spraying.

FIG. 7 is an EDX map showing the elemental distribution correspond to an energy peak overlapping Cr and Mn in a symmetric cell.

FIG. 8 is a Nyquist diagram for a number of demonstration sample cells.

FIG. 9 is an Arrhenius plot for a number of demonstration sample cells.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

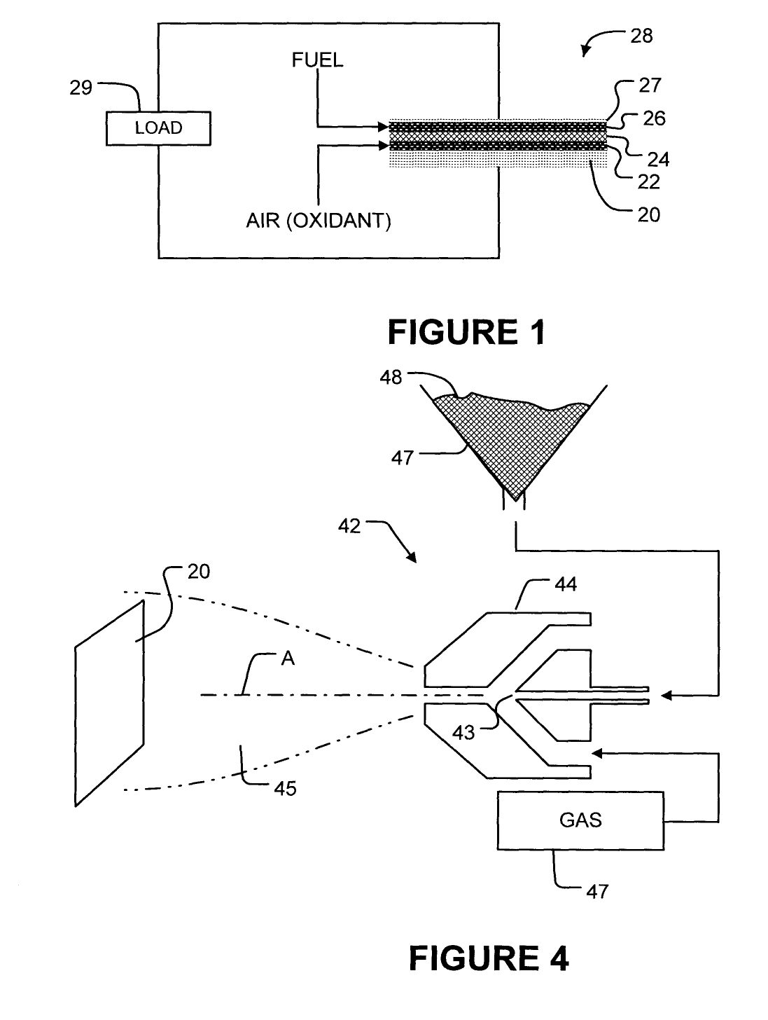

FIG. 1 illustrates the cross-sectional structure of a typical SOFC 28. SOFC 28 has a metallic interconnect 20, a cathode layer 22 in electrical contact with metallic interconnect 20, an electrolyte layer 24, an anode layer 26 and an anode current collector 27. Electrolyte layer 24 is conductive to ions but blocks passage of electrons.

In operation, a fuel is supplied to the anode of SOFC 28 while an oxidant, such as air, is supplied to the cathode of SOFC 28. An SOFC 28 is typically operated at an elevated temperature. Electrochemical reactions occur at the anode and cathode. The reactions cause a potential difference to be established between metallic interconnect 20 and anode-side current collector 27. The potential difference can drive an electrical current through a load 29. A number of SOFCs may be connected in series or parallel to achieve a desired voltage and power.

SOFCs are typically configured as stacks comprising multiple unit cells. In such configurations, interconnects 20 separate the unit cells and provide a path for electrical conductivity between the anode of one unit fuel cell and the cathode of an adjacent unit fuel cell in the stack.

While FIG. 1 shows an SOFC having a planar structure, SOFCs may be supplied in other configurations such as cylindrical configurations. The invention is not limited to planar configurations but may be applied to making SOFCs having cylindrical or other configurations.

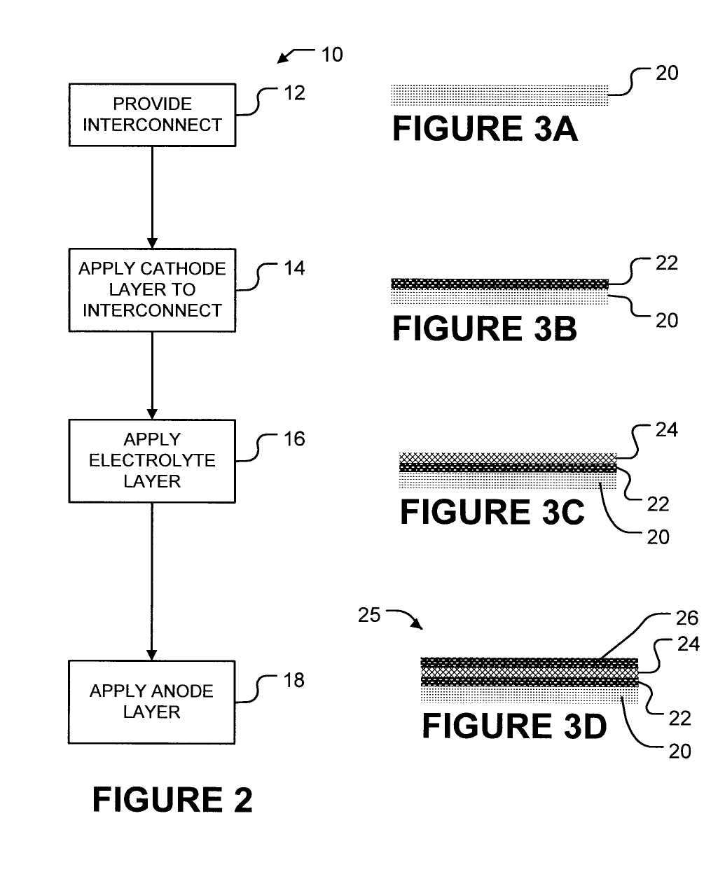

FIG. 2 illustrates a method 10 for fabricating an SOFC 28. Method 10 begins at block 12 with providing a metallic interconnect 20 (see FIG. 3A). A metallic interconnect 20 is electronically conductive.

In some embodiments, the interconnect is impermeable to gas. In such embodiments, the interconnect 20 may prevent air (or another oxidant) from mixing with fuel supplied to an adjacent unit fuel cell, if present.

In preferred embodiments, at least the surface of interconnect 20 is porous. In such embodiments, metallic interconnect 20 allows for the transport of air through pores in the metallic interconnect to reaction sites in the cathode.

Metallic interconnect 20 is made of a material that resists degradation under the expected operating conditions of the SOFC. For example, interconnect 20 may comprise a suitable stainless steel, a nickel-based superalloy, a Cr- or Co-based superalloy or the like. Interconnect 20 may optionally have a surface coating to improve its oxidation-resistance or other characteristics.

The material of metallic interconnect may be selected based upon factors such as:
Design constraints that may require interconnect 20 to have a coefficient of thermal expansion matching that of some other component or structure in a fuel cell system;
Resistance to degradation at a desired operating temperature;
Resistance to degradation under expected thermal cycling; and the like.

In block 14 a cathode layer 22 is deposited directly onto interconnect 20 as illustrated in FIG. 3A. A feature of this invention is that cathode layer 22 is deposited onto the surface of the same component that will function as interconnect 20 in the eventual SOFC made by method 10.

Block 14 may comprise applying the material of cathode layer 22 by thermal spraying. The thermal spraying could comprise high velocity oxy-fuel (HVOF) spraying or plasma spraying, for example. In a preferred embodiment, the thermal spraying comprises plasma spraying. The plasma spraying may comprise, for example, vacuum plasma spraying or atmospheric plasma spraying. Plasma spraying is described, for example, in:
M. Lang, T. Franco, G. Schiller and N. Wagner, J. Appl. Electrochem., 32, 871 (2002).
K. Barthel and S. Rambert, 5th International Symposium on Functionally Graded Materials, p. 800, Trans Tech Publications Ltd. (1998).
R. Zheng, X. M. Zhou, S. R. Wang, T.-L. Wen and C. X. Ding, J. Power Sources, 140, 217 (2005).

The plasma spraying is performed, for example, using an axial-injection or radial-injection plasma spraying system 42. Such plasma spraying systems may be automated and can be used in industrial scale mass production settings. The plasma spraying is preferably performed using an axial-injection plasma spraying system 42. Block 14 may comprise applying the cathode layer 22 to metallic interconnect 20 by atmospheric plasma spraying (APS). In APS, plasma spraying is performed in an air-atmosphere.

In the embodiment illustrated in FIG. 4, plasma spraying system 42 comprises an axial-injection plasma torch 44 comprising a powder injection nozzle 43 that injects a powder 48 from a powder supply 47 along an axis A of a plasma torch 44. The powders become entrained in a hot plasma 45 generated by plasma torch 44 and are carried to interconnect 20. The plasma spraying system 42 may comprise, for example, an Axial plasma spray system available from Northwest Mettech Corp. of North Vancouver, Canada. Plasma spray system 42 includes a suitable controller, electrodes, current supply, cooling system and other supporting systems that are not shown in FIG. 4 for clarity.

Cathode layer 22 comprises a porous layer that permits air to pass to reaction sites in layer 22 during operation of the SOFC. The material of cathode 22 may comprise a suitable ceramic or mixture of ceramics for example. In some embodiments, cathode 22 comprises a mixture of yttria stabilized zirconia (YSZ) with another material such as Lanthanum Strontium Manganate—(La₁₋ₓSrₓ)_{y}MnO_{3-z}, (LSM). Some example compositions for LSM are:
La_{0.8}Sr_{0.2}MnO₃
(La_{0.8}Sr_{0.2})_{0.98}MnO₃
La_{0.85}Sr_{0.15}MnO₃
(La_{0.85}Sr_{0.15})_{0.98}MnO₃

Powder 48 may comprise a mixture of the materials in powdered form. The ratio of YSZ to LSM in some embodiments is 50:50 by volume. Some examples of YSZ-LSM composite cathode materials are described in:
A. Barbucci, R. Bozzo, G. Cerisola and P. Costamagna, Electrochimica Acta, 47, 2183 (2002).
M. J. L. Ostergard, C. Clausen, C. Bagger and M. Mogensen, Electrochim Acta., 40, 1971 (1995).
   The ratio of YSZ to LSM may be varied. Powder 48 may comprise a pore-former, such as graphite, to enhance the porosity of the plasma-sprayed cathode layer.

Metallic interconnect 20 may be cooled during plasma spraying to prevent it from becoming heated to the point that it becomes degraded. Metallic interconnect 20 may be air-cooled or placed in thermal contact with a suitable heat sink or other temperature controlled surface during thermal spraying. Air jets may be directed at metallic interconnect 20 to assist in cooling interconnect 20.

In general, it is desirable that the plasma sprayed cathode should fill any valleys in the surface of interconnect 20 while remaining thin so as to minimize electronic resistance.

Where interconnect 20 is porous, as it is in preferred embodiments, it is also desirable that the material of cathode 22 should make good contact with interconnect 20 but should not fill up and plug all of the pores in interconnect 20. This can be achieved by choosing spray parameters for cathode deposition that result in the partial melting of the cathode material powder particles. Partial melting of the particles allows for good adhesion of the coating resulting from contact between the molten ceramic material of the powders and the metallic interconnect 20. Because the particles are not entirely melted they contain solid portions which enhance the porosity of the resulting cathode layer 22. This prevents the pores in interconnect 20 from being completely filled in by the material of cathode layer 22. The particular operating conditions will vary depending upon the particular plasma spray system 42 being used to apply cathode layer 22. In general, suitable plasma spraying conditions tend to involve low to moderate plasma energy combined with short torch standoff distances.

The microstructure of the plasma-sprayed cathode layer may be controlled by varying the plasma-spraying conditions. The effect of plasma-spraying conditions on the microstructure of plasma-sprayed films is described, for example in the following references, which are hereby incorporated herein by reference:
B. D. White, O. Kesler, N. Ben-Oved and A. Burgess, International Thermal Spray Conference and Exposition (ISTC) 2006, ASM Thermal Spray Society (2006).
B. D. White and O. Kesler, Advanced Materials Research, 15-17, 299 (2007).

Some particular conditions that may be used in applying a plasma-sprayed cathode layer to a metallic interconnect, such as a stainless steel interconnect, are described in the Examples which are set out below.

Deposition of cathode layer 22 directly onto metal interconnect 20 by thermal (e.g. plasma) spraying has additional benefits. The porosity of cathode layer 22 is enhanced since thermal spraying onto a metal substrate can provide more rapid cooling of the thermally-sprayed material. This tends to produce coatings having higher porosity. Higher cathode porosity increases the electrode area available for electrochemical reactions compared to very dense cathodes and improves the transport of reactants through the electrode; both of which improve the electrode performance, and hence improve fuel cell performance.

As an alternative to thermal spraying, cathode layer 22 may be applied to an interconnect 20 by another suitable technique such as screen printing.

In block 16 an electrolyte layer 24 is applied over cathode layer 22 as shown in FIG. 3C. Electrolyte layer 24 may also be applied by plasma spraying. Electrolyte layer 24 is preferably a thin, dense layer which fully covers cathode layer 22.

Applying electrolyte layer 24 by plasma spraying avoids the requirement for the high-temperature thermal treatment (i.e. treatment at or above approximately 1400° C.) that is required by some electrolyte-fabrication processes. Such high-temperature treatment can cause chemical reactions to occur with and between the cathode and electrolyte, which reduces cell performance. Method 10 makes it possible to fabricate the cathode first and to subsequently deposit the electrolyte onto the cathode, which is not practical with many current SOFC manufacturing processes.

Any portions of cathode layer 22 or interconnect 20 that project outwardly from their surroundings (e.g. bumps or hills) should not poke through electrolyte layer 24. This issue can be addressed by providing an interconnect 20 that has a reasonably smooth surface and by applying cathode layer 22 under conditions that achieve a reasonably smooth but porous coating. As mentioned above, this can be achieved by applying cathode layer 22 by plasma spraying while operating under conditions that cause the plasma-sprayed powders to become partially melted during deposition. Too little melting of the particles of cathode material being sprayed tends to lead to an undesirably rough cathode layer 22. A rough cathode layer 22 can interfere with obtaining a dense and continuous electrolyte layer 22. On the other hand, complete melting of the particles of cathode material during deposition can provide a cathode layer 22 that is too dense to have acceptable performance. Particle size of the plasma sprayed powders of cathode materials can also affect the smoothness of cathode layer 22. Smaller particles tend to produce smoother surfaces. However, if the particles are too small, it becomes difficult to cause the particles to be only partially melted during plasma spraying.

By selecting appropriate particle side and plasma conditions one can achieve deposition conditions that melt the particles of cathode material sufficiently to provide a porous cathode layer 22 that has a surface that is smooth enough to support a thin dense continuous electrolyte layer 24.

In block 18 an anode layer 26 is applied over electrolyte layer 24 as shown in FIG. 3D. Anode layer 26 may also be applied by plasma spraying. Anode layer 26 may also be produced by suitable wet ceramic processing techniques. The resulting unit cell structure 25 may be used as a fuel cell or stacked together with other unit cell structures 25 in a fuel cell stack.

### EXAMPLES

In example demonstration embodiments, spray-dried LSM ((La_{0.8}Sr_{0.2})_{0.98}MnO_{3-z}) and YSZ (8 mol % Y₂O₃) powdered feedstocks (Inframat Advanced Materials, Farmington, Conn., U.S.A.) were dry mixed and fed from a single hopper into an Axial III™ Series 600 plasma spraying torch (Northwest Mettech Corp., North Vancouver, BC, Canada). The powders were injected axially into a plasma and deposited directly onto metallic interconnects. The interconnects were porous, one inch (25.4 mm) diameter, 430 stainless steel substrates (Mott Corporation, Farmington, Conn.). The substrates were mounted on a rotating turntable (400 rpm) to prevent overheating during the deposition process.

The powders each had one of the size distributions listed in Table I.

TABLE I
Powder Size Distributions

| Powder | Size Distribution A | Size Distribution B |
|---|---|---|
| LSM | −75 + 45 μm | −45 + 32 μm |
| YSZ | −45 + 32 μm | −32 + 25 μm |

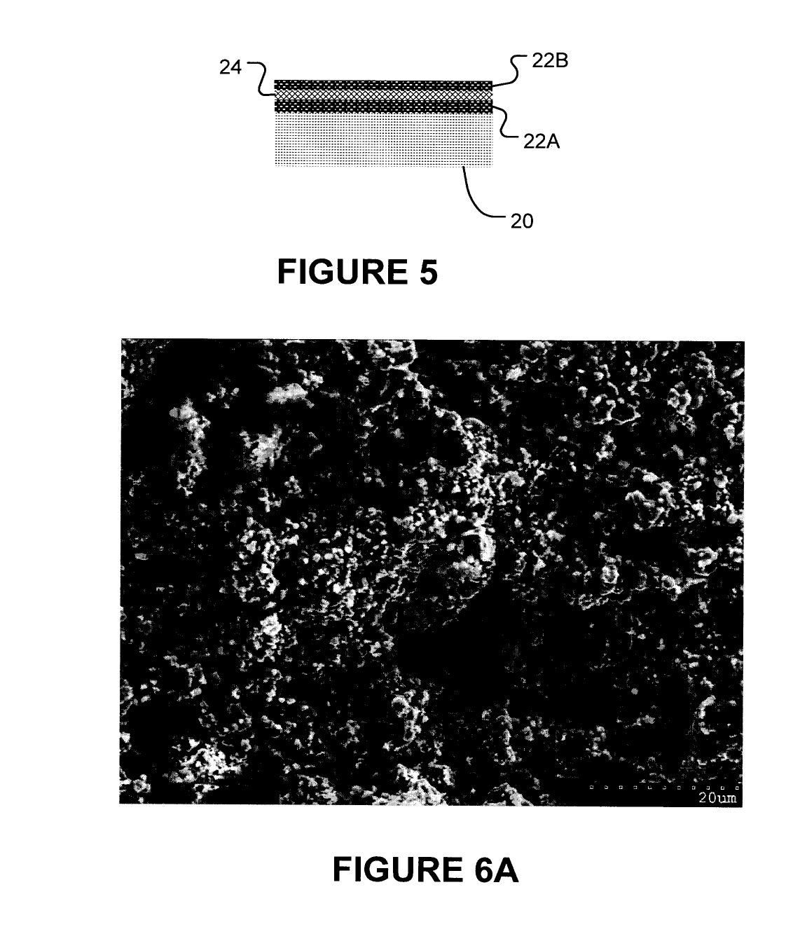

Cathode-cathode symmetric cells were deposited onto the interconnects by plasma spraying. The symmetric cells had the structure shown in cross-section in FIG. 5 with a first cathode layer 22A deposited onto substrate 20, an electrolyte layer 24 deposited on first cathode layer 22A and a second cathode layer 22B deposited over the electrolyte layer.

The electrolyte layers were formed by plasma spray deposition of −25 μm 8 mol % YSZ powder. Identical deposition conditions were used for electrolyte layer 24 in each symmetrical cell. To achieve high density in the electrolyte layer, deposition was carried out in a high energy plasma (87 kW) using 100% N₂ with 250 A torch current at a standoff distance of 120 mm. As cells were being tested in a symmetric cell configuration, gas impermeability of electrolyte layers 24 was not a major concern. All that was required in the demonstration examples is an electrolyte layer 24 sufficiently dense to provide reasonably good ionic conductivity to permit the characteristics of the cathode layers to be studied. The electrolyte layers 24 had thicknesses of approximately 60 μm.

In each symmetric cell, identical deposition conditions were used for cathode layers 22A and 22B (See FIG. 5). Three symmetric cells were produced having cathode layers deposited using three different combinations of parameter values. Two of these combinations of parameter values used relatively low-energy plasmas to produce coatings having relatively porous microstructures. In the third symmetric cell, the cathodes were produced under high plasma energy conditions. Such high plasma energy conditions tend to produce layers having microstructures that are denser than layers produced under lower plasma energy conditions. All of the deposited cathodes had thicknesses of approximately 50 μm.

In each case, the relative amounts of YSZ and LSM in the starting powder composition was adjusted to compensate for the different relative deposition efficiency of LSM and YSZ under the selected plasma conditions to yield cathodes containing approximately 35 vol. % YSZ and 65 vol. % LSM. The conditions used for the deposition of the cathodes in each of the three symmetric cells are set out in Table 2.

TABLE 2
Plasma Spraying Conditions Used for Cathode Deposition

| Sample | #1 | #2 | #3 |
|---|---|---|---|
| Standoff Distance (mm) | 100 | 100 | 100 |
| Plasma Gas Flow Rate (slpm) | 217 | 250 | 183 |
| Plasma Gas Composition | 70% Ar, | 23% Ar, | 23% Ar, |
| | 30% N₂ | 77% N₂ | 77% N₂ |
| Carrier Gas Flow Rate | 5 | 11.7 | 18.3 |
| (slpm) | | | |
| Arc Current (A) | 217 | 183 | 217 |
| LSM Powder Size | −45 + 32 μm | −45 + 32 μm | −75 + 45 μm |
| YSZ Powder Size | −32 + 25 μm | −45 + 32 μm | −45 + 32 μm |
| Feed Rate (g/min) | 10 | 40 | 40 |
| Nozzle Diameter (mm) | 12.7 | 9.52 | 12.7 |

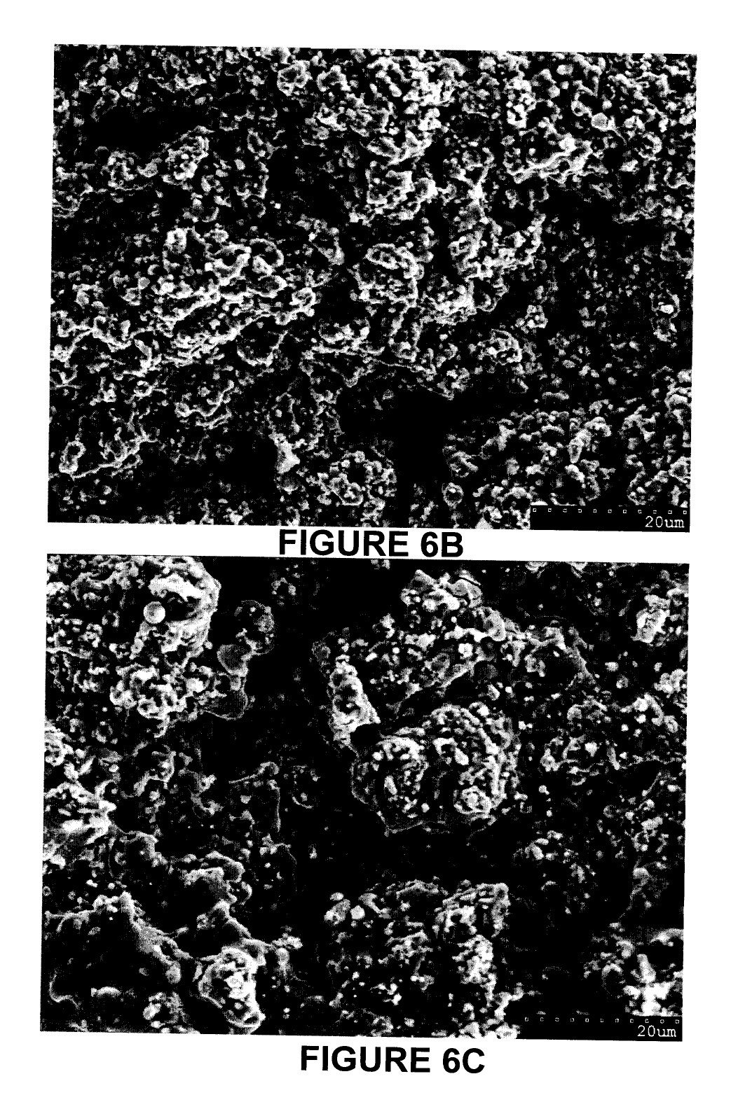

Coating surfaces and cell cross sections were examined by scanning electron microscopy (SEM) to evaluate and compare the coating microstructures. Energy dispersive X-ray spectroscopy (EDX) was used to determine the phases present in the coatings and substrates. FIGS. 6A, 6B and 6C respectively show the microstructures of portions of the top surfaces of coatings of Samples #1, #2 and #3 deposited under the conditions shown in Table 2.

The cathodes produced in lower energy density plasmas (samples #1 and #2) appear much more porous with less extensive melting of the ceramic particles in the coating. While the cathodes in all three cells had approximately the same final thickness, there were large differences in the deposition efficiency, and hence the deposition time, between the three sample cells. The cathode of sample #1 required 120 passes of the plasma torch at 10 g/min deposition rate to achieve a thickness of 50 μm. Only 13 and 12 passes were respectively required under the conditions used for sample #2 and sample #3 at a deposition rate of 40 g/min to achieve the same cathode thickness.

The difference in deposition efficiency is likely the result of differences in the plasma composition, which affects the energy content and temperature of the plasma. The two coatings produced using plasmas containing high levels of N₂ have much higher deposition efficiencies. The higher N₂ content allows for more extensive melting of the LSM and YSZ powders in the plasma and significantly better adhesion to the substrate.

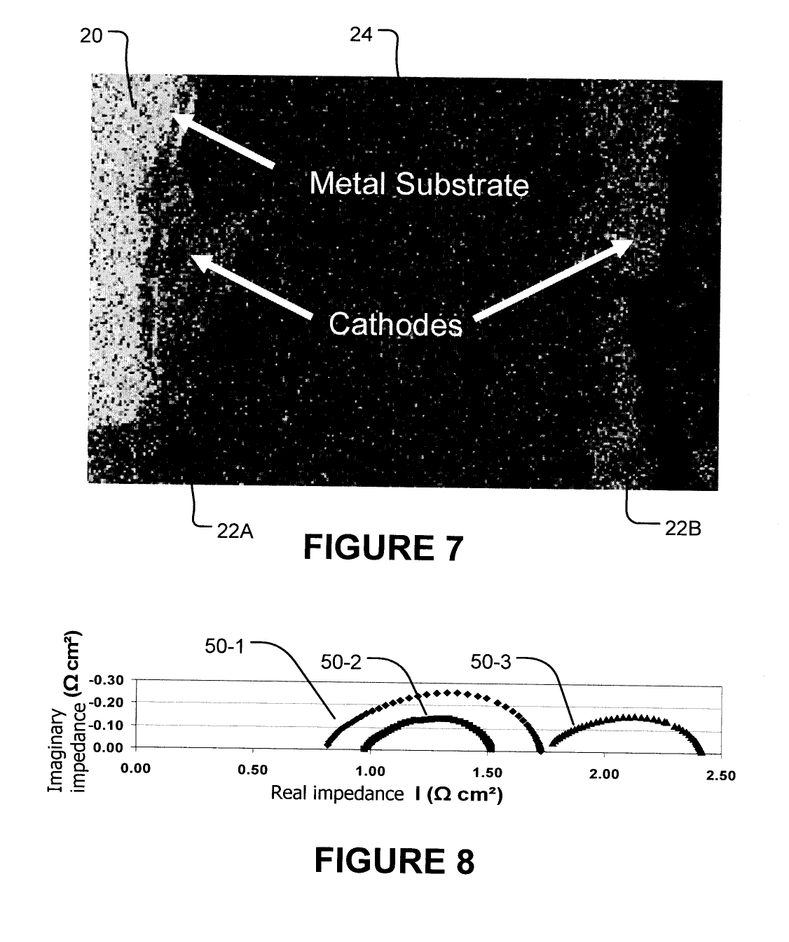

FIG. 7 is an EDX map showing the distribution of elements (lighter areas) in a cell following electrochemical testing having a characteristic energy in a location on the energy spectrum that is common to both Cr and Mn. EDX testing showed Cr in the substrate and Mn in the coatings. In the event that Cr contamination in the cathodes occurs, to prevent degradation of cathode performance resulting from contamination by chromium or other constituent of the interconnect, a suitable coating may be applied to the interconnect.

Electrochemical characterization of the cathodes in the demonstration symmetric cells was carried out using EIS measurements (SI 1260 frequency response analyzer, Solartron Analytical, Farnborough, UK) at six temperatures ranging from 650° C. to 900° C. to determine the polarization resistance (Rₚ) and activation energy of the cathodes. The cells were held for two hours at each temperature with impedance measurements taken every fifteen minutes. Tests were performed in an air atmosphere with a total flow rate to both cathodes of 0.1 slpm.

Impedance measurements were carried out at OCV with an AC voltage amplitude of 50 mV over a range of frequencies between 1 MHz and 1-0.01 Hz, depending on the measurement temperature.

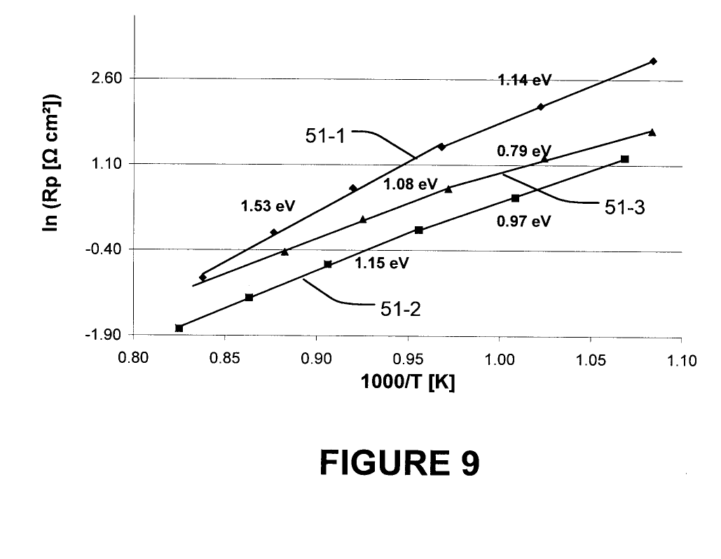

The results of the electrochemical performance evaluations of the three sample cells are shown in FIGS. 8 and 9. FIG. 8 is a set of normalized Nyquist plots showing the lowest cathode Rₚ measured in the three cells tested. Curve 50-1 is for sample #1 at 860° C. Curve 50-2 is for sample #2 at 830° C. Curve 50-3 is for sample #3 at 860° C.

At all of the temperatures tested, sample #2 had the best performance of the three cells, achieving a minimum Rₚ of 0.17 Ωcm² at 940° C. The sample #1 cell was found to have the highest polarization resistance at all of the temperatures examined. Examination of the surface of the cathode deposited directly on the metal substrate of the sample #1 cell revealed that a significant amount of bare substrate was visible. It is thought that the incomplete coverage of the metallic interconnect with this cathode resulted in impaired performance due to a reduced area available for electrochemical reactions to occur. The cell of sample #3 had an Rₚ falling between that of the two other more porous cells.

FIG. 9 is an Arrhenius plot showing the relationship between Rp and inverse temperature for each sample cell and the corresponding activation energy. Curves 51-1, 51-2 and 51-3 are respectively for samples #1, #2 and #3.

All three cells were found to have different activation energies, as seen in FIG. 9. The activation energies ranged from 0.79 eV to 1.53 eV, indicating some differences in the rate limiting mechanisms. Additionally, all three cells exhibited an increase in activation energy at temperatures above approximately 750° C.

The demonstration embodiments show that LSM/YSZ composite cathodes with satisfactory performance can be successfully fabricated by APS onto metallic interconnects.

Various embodiments of the invention may have significant advantages. For example:
fabricating a cathode by plasma deposition directly onto a metallic interconnect can greatly reduce cost and processing time relative to “wet” methods for SOFC fabrication;
when the cathode is fabricated by direct deposition onto a metallic interconnect, the thickness of other layers, such as the electrolyte layer, may be reduced, thereby saving cost and potentially improving performance.
the electrical contact between the cathode and interconnect can be improved as compared to fuel cell structures in which the cathode is fabricated separately from the interconnect.

While a number of exemplary aspects and embodiments have been discussed above, those of skill in the art will recognize certain modifications, permutations, additions and sub-combinations thereof that come within the scope of this invention.

1. A method for making a solid oxide fuel cell, the method comprising:
depositing a porous cathode layer directly onto a metallic interconnect and depositing one or more additional layers on the deposited cathode layer.

2. (canceled)

3. A method according to claim 1 wherein depositing one or more of the cathode material and the one or more additional layers comprises thermal spraying.

4. A method according to claim 1 wherein depositing one or more of the cathode layer and the one or more additional layers comprises plasma spraying.

5. A method according to claim 4 wherein the plasma spraying comprises atmospheric plasma spraying.

6. A method according to claim 4 wherein the plasma spraying comprises vacuum plasma spraying.

7. A method according to claim 4 wherein the plasma spraying comprises injecting material axially into a plasma, heating the material in the plasma and depositing the heated material.

8. A method according to claim 4 wherein the plasma spraying comprises partially-melting material for the cathode layer or the one or more additional layers before depositing the material.

9. (canceled)

10. (canceled)

11. A method according to claim 4 comprising depositing the one or more additional layers by plasma spraying and maintaining a temperature of the cathode layer below 1300° C. during the plasma spray deposition of the one or more additional layers.

12. (canceled)

13. A method according to claim 1 wherein the one or more additional layers comprise an electrolyte layer in contact with the cathode layer, the method comprises plasma spray deposition of the electrolyte layer and the plasma spray deposition of the electrolyte layer comprises plasma spraying using nitrogen as a plasma gas.

14. (canceled)

15. A method according to claim 1 wherein a surface of the metallic interconnect is porous.

16-22. (canceled)

23. A method according to claim 1 wherein depositing the cathode layer comprises feeding cathode material as a powder into a plasma spraying torch.

24. A method according to claim 23 wherein the powder comprises a mixture of two or more different ceramic materials.

25. A method according to claim 24 wherein the two or more different ceramic materials comprise yttria-stabilized zirconia.

26. A method according to claim 25 wherein the two or more different ceramic materials comprise lanthanum strontium manganate.

27. A method according to claim 23 wherein the powder comprises a pore former.

28. (canceled)

29. A method according to claim 1 wherein the metallic interconnect comprises a metal selected from the group consisting of: stainless steel, nickel-based superalloy, chromium-based superalloy, and cobalt-based superalloy.

30. (canceled)

31. A method according to claim 1 wherein the cathode layer has a thickness of 50 μm±10 μm.

32. A solid oxide fuel cell cathode component comprising a porous thermal-sprayed layer of a cathode material formed directly onto a metallic interconnect.

33.-41. (canceled)

42. A solid oxide fuel cell component according to claim 32 wherein the metallic interconnect comprises a metal selected from the group consisting of: stainless steel, nickel-based superalloy, chromium-based superalloy, and cobalt-based superalloy.

43. A solid oxide fuel cell component according to claim 32 wherein the thermal-sprayed layer of ceramic cathode material comprises a layer of ceramic cathode material deposited by injecting material axially into a plasma in a plasma torch and depositing the material.

44. A method for making a solid oxide fuel cell component, the method comprising:
depositing a porous cathode material layer directly onto a porous metallic support structure and depositing one or more additional layers on the deposited cathode layer.
